(19) United States
(12) Patent Application Publication
(10) Pub. No.: US 2009/0138740 A1
(43) Pub. Date: May 28, 2009

(54) METHOD AND COMPUTER DEVICE CAPABLE OF DEALING WITH POWER FAIL

(75) Inventor: Wen-Chiang Fan, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/018,628

(22) Filed: Jan. 23, 2008

(30) Foreign Application Priority Data
Nov. 22, 2007 (TW) 96144301

(51) Int. Cl. G06F 1/28; G06F 11/30; G06F 13/24

(52) U.S. Cl. 713/340; 710/267; 714/47

(57) ABSTRACT

A method capable of dealing with a power fail is adapted for a control board with power thereof supplied from a power supply. The control board has a processor and a memory disposed thereon. The present method includes firstly determining whether or not an alternating current input to the power supply is normal. Next, when the alternating current is judged to be abnormal, a non-maskable interrupt signal is triggered to the processor. Thereafter, the processor writes a record of alternating current fail into the memory. In addition, a computer device capable of dealing with a power fail is also provided.

### CROSS-REFERENCE TO RELATED APPLICATION

This application claims the priority benefit of Taiwan application serial no. 96144301, filed on Nov. 22, 2007. The entirety of the above-mentioned patent application is hereby incorporated by reference herein and made a part of this specification.

### BACKGROUND OF THE INVENTION

1. Field of the Invention

The present invention relates to a power management method and a computer device using the same. More particularly, the present invention relates to a method capable of dealing with power fail and a computer device using the same.

2. Description of Related Art

As to computer devices such as personal computers and servers etc., power management thereof is essential. Presently, most of the computer systems may support an advanced configuration and power interface (ACPI) standard to implement the power management. The ACPI may manage a power supply via an operating system other than a basic input output system (BIOS) according to interactive between a user and the operating system, and therefore efficiency of the power management is improved. The ACPI may effectively distribute power to system devices, and in coordination with information such as temperature of main board, fan speed and voltage a host may be provided, and meanwhile energy is saved and efficiency of the computer system is improved.

However, as to the computer devices with power thereof supplied from power supplies, sudden power fail is a big problem. For a server requiring a relatively high reliability, when the power thereof is failed, and the server is restarted, certain settings or operations need to be performed to the server. However, according to the present technique, a manager cannot determine the reason of power fail, i.e. whether it is because a sudden power fail of an alternating current power supply or because the power supply cannot transform an alternating current to a direct current is unsure.

### SUMMARY OF THE INVENTION

The present invention is directed to a method capable of dealing with a power fail, by which a user may find the reason of the power fail.

The present invention is directed to a computer device capable of dealing with a power fail, which may apply the aforementioned method.

The present invention provides a method capable of dealing with a power fail, which is adapted for a control board with power thereof supplied from a power supply. The control board has a processor and a memory thereon. The present method includes first determining whether or not an alternating current input to the power supply is normal. Next, triggering a non-maskable interrupt (NMI) signal to the processor when the alternating current is judged to be abnormal. Thereafter, writing a record of an alternating current fail into the memory via the processor.

In an embodiment of the present invention, the method capable of dealing with the power fail further includes providing an interrupt controller disposed on the control board.

In an embodiment of the present invention, the step of triggering the NMI signal includes triggering the NMI signal to the processor via the interrupt controller.

In an embodiment of the present invention, the step of determining whether or not the alternating current is normal includes determining whether or not the alternating current is normal via the interrupt controller.

In an embodiment of the present invention, the method capable of dealing with the power fail further includes first determining whether or not a direct current output from the power supply is normal. Next, triggering a non-maskable interrupt (NMI) signal to the processor when the direct current is judged to be abnormal. Thereafter, writing a record of a direct current fail into the memory via the processor.

In an embodiment of the present invention, the step of determining whether or not the direct current is normal includes first monitoring an output voltage of the power supply. Next, judging whether or not the output voltage is less than a threshold value, wherein the threshold value may be greater than a minimum working voltage of the processor.

In an embodiment of the present invention, the method capable of dealing with the power fail further includes first reading the record of the alternating current fail and sending a warning signal via the processor when the control board is restarted, so as to warn occurring of the alternating current fail before the control board is restarted. Next, eliminating the record of the alternating current fail stored in the memory, wherein method of sending the warning signal includes sending a warning sound or a twinkling light.

The present invention further provides a computer device capable of dealing with power fail. The computer device includes a control board, a power supply, a processor, an interrupt controller and a memory. The power supply is used for providing power to the control board. The processor is disposed on the control board. The interrupt controller is disposed on the control board and coupled to the power supply and the processor, and is used for determining whether or not an alternating current input to the power supply is normal. If the alternating current is judged to be abnormal, a NMI signal is triggered to the processor. The memory is coupled to the processor. The processor writes a record of the alternating current fail into the memory when the NMI signal is triggered.

In an embodiment of the present invention, the interrupt controller may be used for determining whether or not a direct current output from the power supply is normal, and when the direct current is judged to be abnormal, a NMI signal is triggered to the processor, such that the processor may write a record of the direct current fail to the memory.

In an embodiment of the present invention, the interrupt controller may be used for monitoring an output voltage of the power supply, so as to determine whether or not the direct current output from the power supply is normal by judging whether or not the output voltage is less than a threshold value, wherein the threshold value is greater than a minimum working voltage of the processor.

In an embodiment of the present invention, the interrupt controller may be a field-programmable gate array (FPGA).

In an embodiment of the present invention, the memory may be a complementary metal-oxide semiconductor (CMOS), and is suitable for storing a setting value of a basic input output system (BIOS).

In an embodiment of the present invention, the memory may be a non-volatile memory.

According to the present invention, when the input power or the output power of the power supply is judged to be failed, the processor may write the record of power fail into the memory. Therefore, a user may judge whether it is the alternating current fail or a power supply fail according to the record of the power fail.

In order to make the aforementioned and other objects, features and advantages of the present invention comprehensible, a preferred embodiment accompanied with figures is described in detail below.

### BRIEF DESCRIPTION OF THE DRAWINGS

FIG. 1A is a diagram of a computer device capable of dealing with a power fail according to a first embodiment of the present invention.

FIG. 1B is a flowchart illustrating a method for dealing with an alternating current fail applied by the computer device of FIG. 1A.

FIG. 1C is a flowchart illustrating a method for dealing with a direct current fail applied by the computer device of FIG. 1A.

FIG. 2A is a diagram illustrating a computer device capable of dealing with a power fail according to a second embodiment of the present invention.

FIG. 2B is a flowchart illustrating a method for dealing with a direct current fail applied by the computer device of FIG. 2A.

FIG. 2C is a schematic diagram illustrating a relation between time and output voltages monitored by the interrupt controller of FIG. 2A.

### DESCRIPTION OF EMBODIMENTS

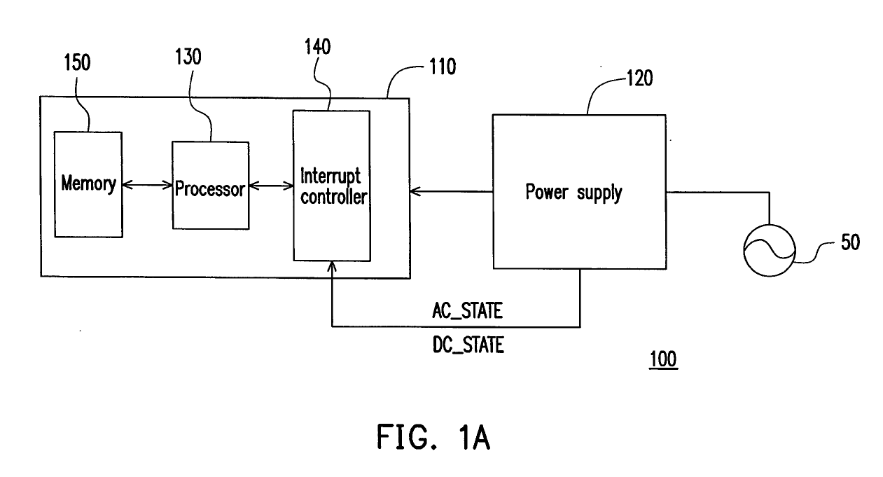

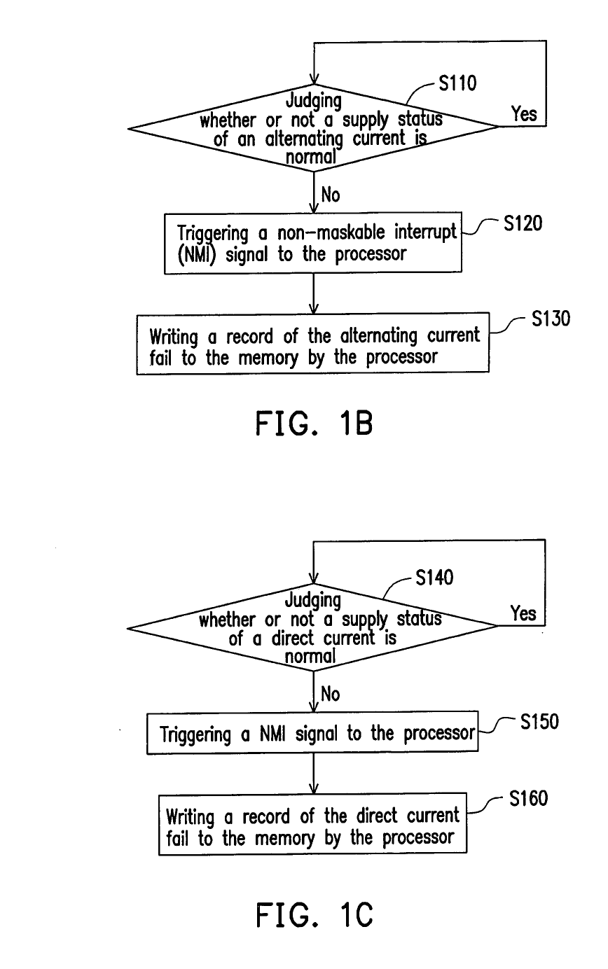

FIG. 1A is a diagram of a computer device capable of dealing with a power fail according to a first embodiment of the present invention. Referring to FIG. 1A, the computer device 100 mainly includes a control board 110. The computer device may be a personal computer, and the control board 110 may be a main board of the personal computer. The control board 110 has a processor 130 and a memory 150 disposed thereon. The processor 130 is coupled to the memory 150. The control board 110 is coupled to a power supply 120 for receiving power from the power supply 120. The power supply 120 may be connected to an alternating current (AC) power supply 50 for transforming an alternating current output from the AC power supply 50 into a direct current, so as to provide the direct current to the control board 110.

FIG. 1B is a flowchart illustrating a method for dealing with an alternating current fail applied by the computer device of FIG. 1A. Referring to FIGS. 1A and 1B, first, in step S110, whether or not an alternating current input to the power supply 120 is normal is judged. In the present embodiment, the power supply 120 may provide an alternating current signal AC_state to the control substrate 110. The control board 110 may judge whether or not the alternating current input to the power supply 120 is normal according to the received signal AC_STATE.

When the alternating current fail such as power off is judged, in step S120, a NMI signal is triggered to the processor 130. To be specific, the control board 110 may further have an interrupt controller 140 (referring to FIG. 1A). The interrupt controller 140 may be coupled to the processor 130. When the alternating current fail is judged, the NMI signal may be triggered to the processor 130 via the interrupt controller 140. Moreover, in another embodiment, the interrupt controller 140 may also be used for receiving the signal AC_STATE, so as to judge whether or not the alternating current input to the power supply 120 is normal.

Next, in step S130, the processor 130 writes a record of the alternating current fail into the memory 150. In detail, the memory 150 may be a CMOS used for storing a setting value of a BIOS. During starting of the computer device 100, the BIOS is generally started first, and when the computer device 100 is restarted, the BIOS may read the setting value from the memory 150, and judge whether the record of the alternating current fail is stored within the memory 150. If the BIOS judges the record of the alternating current fail is stored in the memory 150, the BIOS may send a warning signal to the user. Wherein, the warning signal may be send as a warning sound or a twinkling light.

When the user hears the warning sound or observes the twinkling light, he may know that the computer device 100 is restarted due to the alternating current fail. While the warning signal is sent or after the warning signal is sent, the record of the alternating current fail stored within the memory 150 may be eliminated, so as to avoid repeat sending of the warning signal if the computer device 100 is again restarted.

In addition, in another embodiment, the memory 150 may be a non-volatile memory, and no matter the memory 150 is the aforementioned COMS or the non-volatile memory, besides sending the warning signal via the BIOS, the record of alternating current fail stored within the memory 150 may be read by a system manage program after entering the operating system, and the record may be further stored within a log file, such that the user may check a status of the power supply by reading the log file. After warning the user the alternating current fail or storing the record of alternating current fail into the log file, the operating system may further eliminate the record of the alternating current fail stored within the memory 150.

Furthermore, if the computer device 100 has the problem of being abnormally shutdown or restarted, and meanwhile no record of the alternating current fail is stored within the memory 150, it may indirectly deduce that the power supply 120 may have a problem. Therefore, the user may find the reason of power fail by judging whether the power supply 120 has a problem or the AC power supply 50 has a problem, and may solve the problem by changing the power supply 120 or further checking the AC power supply 50.

In addition, FIG. 1C is a flowchart illustrating a method for dealing with a direct current fail applied by the computer device of FIG. 1A. Referring FIG. 1A and FIG. 1C, in the present embodiment, the power supply 120 may further provide a direct current signal DC_STATE to the control board 110. The control board 110 may judge whether or not the direct current input to the power supply 120 is normal according to the received DC signal DC_STATE (step S140). When the control board 110 judges a direct current fail according to the received DC signal DC_STATE, a NMI signal is triggered to the processor 130 via the interrupt controller 140 (step S150). Next, the processor 130 may write the record of the direct current fail into the memory 150. When the computer device 100 is restarted, whether or not the power supply 120 is abnormal then may be judged according to whether or not the record of the direct current fail is stored within the memory 150 (step S160).

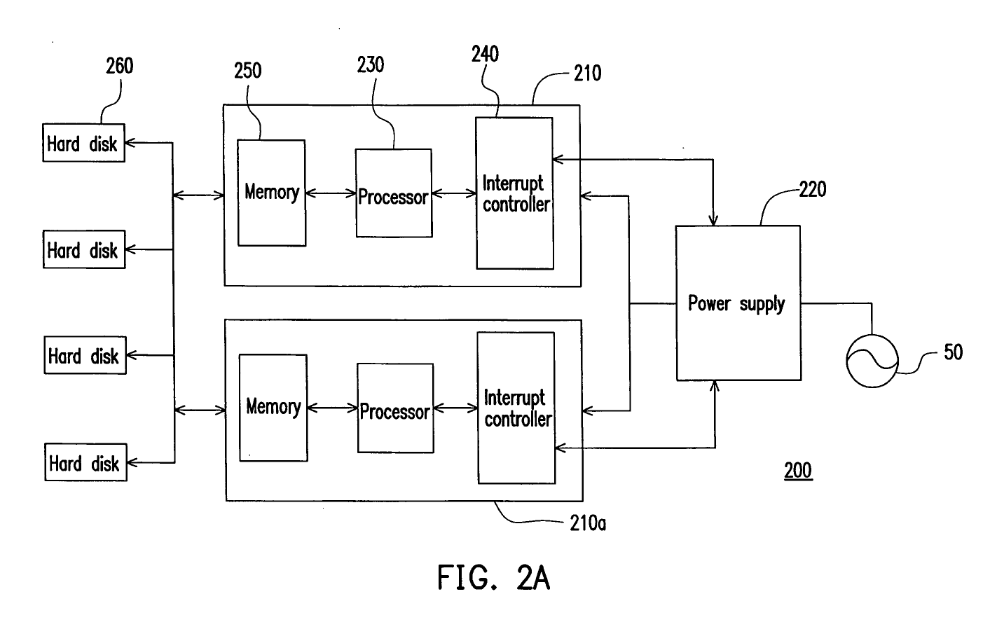

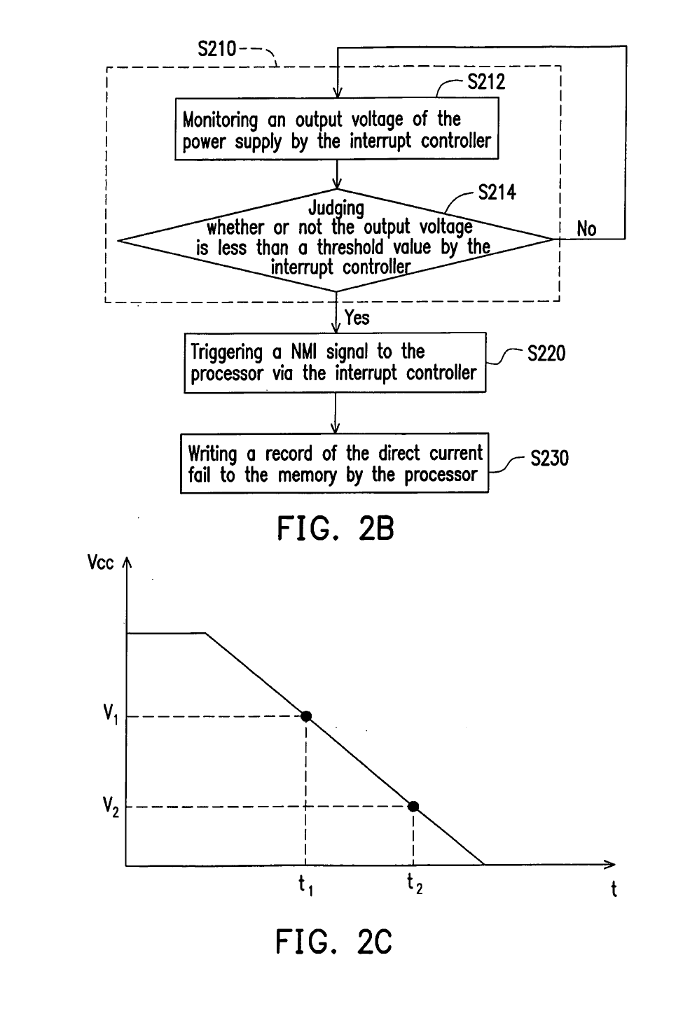

FIG. 2A is a diagram illustrating a computer device capable of dealing with a power fail according to a second embodiment of the present invention. Referring to FIG. 2A and FIG. 1A, the computer device 200 of the present embodiment is similar to the computer device 100 of the first embodiment, except that compared to the interrupt controller 140, the interrupt controller 240 of the present embodiment may be used for monitoring an output voltage of a power supply 220, so as to judge whether or not a direct current output from the power supply 220 is normal according to whether or not the output voltage is less than a threshold value. In another embodiment, the interrupt controller 240 may also be used for detecting whether or not an alternating current input to the power supply 220 is normal.

In the present embodiment, the computer device 200 may be a server, and may further includes a plurality of hard disks 260 used for storing data. The control board 210 may be connected to the hard disks 260 for controlling the hard disks 260 to perform data exchange and data transmission. Moreover, the computer device 200 may further includes a backup control board 210a. The control board 210a has the same function with that of the control board 210, and when the control board 210 is removed from the computer device 200 or cannot work properly, the control board 210a may substitute the control board 210.

FIG. 2B is a flowchart illustrating a method for dealing with a direct current fail applied by the computer device of FIG. 2A. Referring to FIG. 2A and FIG. 2B, first, in step S210, whether or not a direct current output from the power supply 220 is normal is judged. The step S210 includes two sub-steps of step S212 and S214, and in the step S212, the interrupt controller 240 monitors an output voltage of the power supply 220. Next, in the step S214, the interrupt controller 240 judges whether or not the output voltage is less than a threshold value. Thereafter, when the direct current fail is judged, step S220 is executed, by which a NMI signal is triggered to a processor 230. Next, in step S230, the processor 230 writes the record of the direct current fail into a memory 250.

For example, FIG. 2C is a schematic diagram illustrating a relation between time and output voltages monitored by the interrupt controller of FIG. 2A. Referring to FIG. 2C, the vertical axis represents output voltages Vcc monitored by the interrupt controller 240, and the horizontal axis is a time axis t. A voltage value V1 is the threshold value, and a voltage value V2 may be a minimum working voltage for the processor 230. When the output voltage Vcc monitored by the interrupt controller 240 drops to the threshold value V1 at a time point t1, the interrupt controller 240 then may judge a direct current fail. Next, before a time point t2, the interrupt controller 240 triggers the NMI signal to the processor 230 (the step S220), and the processor 230 writes the record of the direct current fail to the memory 250 (the step S230).

To provide an enough time for completing the steps S220 and S230, an energy storage unit (not shown) may be provided to the control board 210 or the power supply 220, so as to prolong dropping of the voltage Vcc. Wherein, the energy storage unit may be a plurality of capacitors. Furthermore, if the control board 210 is hot pulled out, the steps S220 and S230 may still be complete based on the energy storage unit. When the control board 210 is restarted and functions normally, the user may check whether or not the record of the direct current fail is stored within the memory 250 via the operating system or the BIOS, so as to find the reason of sudden shutdown.

In summary, when the input power or the output power of the power supply is failed, such power fail is recorded into the memory by the process. Therefore, the user may find whether the alternating current is failed or the power supply has a problem according to the record of the power fail. Moreover, when the control board or the computer device is restarted, the system may further send the warning signal such as the warning sound etc. according to the record of the power fail, such that the user may easily find the reason of the power fail.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method capable of dealing with a power fail, adapted for a control board with power thereof supplied from a power supply, wherein the control board comprises a processor and a memory, the method comprising:
judging whether or not an alternating current input to the power supply is normal;
triggering a non-maskable interrupt (NMI) signal to the processor when the alternating current is judged to be abnormal; and
writing a record of the alternating current fail to the memory by the processor.

2. The method capable for dealing with a power fail as claimed in claim 1 further comprising: providing an interrupt controller disposed on the control board.

3. The method capable for dealing with a power fail as claimed in claim 2, wherein the step of triggering the NMI signal comprises: triggering the NMI signal to the processor via the interrupt controller.

4. The method capable for dealing with a power fail as claimed in claim 2, wherein the step of judging whether or not the alternating current is normal comprises: judging whether or not a supply status of the alternating current is normal via the interrupt controller.

5. The method capable for dealing with a power fail as claimed in claim 1 further comprising:
judging whether or not a direct current output from the power supply is normal;
triggering a NMI signal to the processor when the direct current is judged to be abnormal; and
writing a record of the direct current fail to the memory by the process.

6. The method capable for dealing with a power fail as claimed in claim 5, wherein the step of judging whether or not the direct current is normal comprises:
monitoring an output voltage of the power supply; and
judging whether or not the output voltage is less than a threshold value.

7. The method capable for dealing with a power fail as claimed in claim 6, wherein the threshold value is greater than a minimum working voltage of the processor.

8. The method capable for dealing with a power fail as claimed in claim 1 further comprising:
reading the record of alternating current fail and sending a warning signal by the processor when the control board is restarted, so as to warn occurring of the alternating current fail before the control board is restarted; and
eliminating the record of alternating current fail stored within the memory.

9. The method capable for dealing with a power fail as claimed in claim 8, wherein the step of sending the warning signal comprises: sending a warning sound or a twinkling light.

10. A computer device capable of dealing with a power fail, comprising:
a control board;
a power supply, for providing power to the control board;
a processor, disposed on the control board;
an interrupt controller, disposed on the control board and coupled to the power supply and the processor, for judging whether or not an alternating current input to the power supply is normal, and triggering a NMI signal to the processor when the alternating current is judged to be abnormal; and
a memory, coupled to the processor, wherein when the NMI is triggered, the processor writes a record of the alternating current fail into the memory.

11. The computer device capable of dealing with a power fail as claimed in claim 10, wherein the interrupt controller is used for judging whether or not a direct current output from the power supply is normal, and triggering a NMI signal to the processor when the direct current is judged to be abnormal, so as to writes a record of the direct current fail to the memory via the processor.

12. The computer device capable of dealing with a power fail as claimed in claim 11, wherein the interrupt controller is used for monitoring an output voltage of the power supply, so as to judge whether or not the direct current output from the power supply is normal by judging whether or not the output voltage is less than a threshold value.

13. The computer device capable of dealing with a power fail as claimed in claim 12, wherein the threshold value is greater than a minimum working voltage of the processor.

14. The computer device capable of dealing with a power fail as claimed in claim 10, wherein the interrupt controller is a field-programmable gate array (FPGA).

15. The computer device capable of dealing with a power fail as claimed in claim 10, wherein the memory is a complementary metal-oxide semiconductor (CMOS), and is suitable for storing a setting value of a basic input output system (BIOS).

16. The computer device capable of dealing with a power fail as claimed in claim 10, wherein the memory is a non-volatile memory.
